(19) United States
(12) Patent Application Publication
(10) Pub. No.: US 2026/0269305 A1
(43) Pub. Date: Sep. 10, 2026

(54) SOLID-ELECTROLYTE BATTERY

(71) Applicant: TDK Corporation, Tokyo (JP)

(72) Inventors: Youhei NODA, Tokyo (JP); Masato KURIHARA, Tokyo (JP)

(73) Assignee: TDK Corporation, Tokyo (JP)

(21) Appl. No.: 19/165,010

(22) PCT Filed: Mar. 15, 2024
(86) PCT No.: PCT/JP2024/010367

§ 371 Date: Sep. 12, 2025

(30) Foreign Application Priority Data
Mar. 17, 2023 (JP) 2023-043374

(51) Int. Cl. H01M 10/0562; H01M 10/0525

(52) U.S. Cl. CPC H01M 10/0562; H01M 10/0525; H01M 2300/008

(57) ABSTRACT

This solid electrolyte battery includes: a positive electrode; a negative electrode; and a solid electrolyte layer sandwiched between the positive electrode and the negative electrode. The solid electrolyte layer contains a solid electrolyte containing Li, Zr, SOₓ, and one or more halogens. A first region of the solid electrolyte layer which is in contact with the negative electrode contains P. The solid electrolyte layer has a molar ratio of SOₓ to Zr of 0.25 to 3.0, a molar ratio of P to Zr of 0.02 to 0.6, and a molar ratio of the halogens to Zr of 3.0 to 6.1.

### TECHNICAL FIELD

The present invention relates to a solid electrolyte battery.

Priority is claimed on Japanese Patent Application No. 2023-043374, filed Mar. 17, 2023, the content of which is incorporated herein by reference.

### BACKGROUND ART

In recent years, the development of electronics technology has been remarkable, and portable electronic devices have been made smaller, lighter, thinner, and multifunctional. Accordingly, there is a strong demand for batteries that serve as power sources for electronic devices to be smaller, lighter, thinner, and more reliable, and solid electrolyte batteries that use a solid electrolyte as an electrolyte have been attracting attention. Solid electrolytes such as oxide solid electrolytes, sulfide solid electrolytes, complex hydride solid electrolytes, and halide solid electrolytes are known.

For example, Patent Document 1 discloses a halide solid electrolyte containing Li, M, O, X, and A. In addition, Patent Document 2 discloses a halide solid electrolyte containing a predetermined compound.

### CITATION LIST

### Patent Documents

Patent Document 1: PCT International Publication No. WO2022/091565(A)
Patent Document 2: PCT International Publication No. WO2021/261558(A)

### SUMMARY OF INVENTION

### Technical Problem

Halide solid electrolytes are said to have a higher ionic conductivity than oxide solid electrolytes, sulfide solid electrolytes, complex hydride solid electrolytes, and the like. However, when a halide solid electrolyte is used together with a negative electrode having a low potential of 0.8 V or less, the solid electrolyte is reduced, and the stability of the solid electrolyte battery decreases.

The present disclosure has been made in consideration of the above-described problem, and an object of the present disclosure is to provide a solid electrolyte battery in which the solid electrolyte is less likely to be reduced and which has high stability.

### Solution to Problem

The present disclosure provides the following means to solve the above-described problem.
(1) A solid electrolyte battery according to a first aspect includes: a positive electrode; a negative electrode; and a solid electrolyte layer sandwiched between the positive electrode and the negative electrode. The solid electrolyte layer contains a solid electrolyte containing Li, Zr, SOₓ, and one or more halogens. A first region of the solid electrolyte layer which is in contact with the negative electrode contains P. The solid electrolyte layer has a molar ratio of SOₓ to Zr of 0.25 to 3.0, a molar ratio of P to Zr of 0.02 to 0.6, and a molar ratio of the halogens to Zr of 3.0 to 6.1.
(2) In the solid electrolyte battery according to the above-described aspect, the solid electrolyte layer may have a molar ratio of Li to Zr of 1.5 to 5.0.
(3) In the solid electrolyte battery according to the above-described aspect, the solid electrolyte layer may have a molar ratio of SOₓ to Zr of 1.0 to 3.0.
(4) In the solid electrolyte battery according to the above-described aspect, the solid electrolyte layer may have a molar ratio of P to Zr of 0.05 to 0.3.
(5) In the solid electrolyte battery according to the above-described aspect, the first region may contain a phosphorus compound.
(6) In the solid electrolyte battery according to the above-described aspect, the phosphorus compound may contain a phosphorus oxide.
(7) In the solid electrolyte battery according to the above-described aspect, the solid electrolyte layer may contain lithium oxide powder.
(8) In the solid electrolyte battery according to the above-described aspect, the negative electrode may have a negative electrode current collector and a negative electrode active material layer. The negative electrode active material layer is provided between the negative electrode current collector and the solid electrolyte layer. The negative electrode active material layer contains lithium metal.
(9) In the solid electrolyte battery according to the above-described aspect, the negative electrode may have a negative electrode current collector, and lithium metal may precipitate between the negative electrode current collector and the solid electrolyte layer during charging, and may dissolve during discharging.
(10) In the solid electrolyte battery according to the above-described aspect, the negative electrode may have a negative electrode current collector and a negative electrode active material layer. The negative electrode active material layer is provided between the negative electrode current collector and the solid electrolyte layer. The negative electrode active material layer contains any one or more selected from graphite, silicon, tin, and silver.
(11) In the solid electrolyte battery according to the above-described aspect, the negative electrode may contain the solid electrolyte and P. The negative electrode has a molar ratio of SOₓ to Zr of 0.25 to 3.0, a molar ratio of P to Zr of 0.02 to 0.6, and a molar ratio of the halogens to Zr of 3.0 to 6.1.
(12) In the solid electrolyte battery according to the above-described aspect, the negative electrode may have a molar ratio of Li to Zr of 1.5 to 5.0.
(13) In the solid electrolyte battery according to the above-described aspect, the negative electrode may have a molar ratio of SOₓ to Zr of 1.0 to 3.0.
(14) In the solid electrolyte battery according to the above-described aspect, the negative electrode may have a molar ratio of P to Zr of 0.05 to 0.3.
(15) In the solid electrolyte battery according to the above-described aspect, the negative electrode may contain a phosphorus compound.
(16) In the solid electrolyte battery according to the above-described aspect, the phosphorus compound may contain a phosphorus oxide.
(17) In the solid electrolyte battery according to the above-described aspect, the negative electrode may contain lithium oxide powder.
(18) In the solid electrolyte battery according to the above-described aspect, the positive electrode may contain the solid electrolyte and P. The positive electrode has a molar ratio of SOₓ to Zr of 0.25 to 3.0, a molar ratio of P to Zr of 0.02 to 0.6, and a molar ratio of the halogens to Zr of 3.0 to 6.1.

### Advantageous Effects of Invention

In the solid electrolyte battery according to the above-described aspect, the solid electrolyte is less likely to be reduced and is stable.

### BRIEF DESCRIPTION OF DRAWING

FIG. 1 is a cross-sectional schematic view of a solid electrolyte battery according to the present embodiment.

### DESCRIPTION OF EMBODIMENT

Hereinafter, the present embodiment will be described in detail with reference to the accompanying drawing as appropriate. In the drawings used in the following description, a part that becomes a feature of the present invention is sometimes enlarged for convenience in order to allow the feature to be easily understood, and the dimensional ratios of each constituent element and the like are sometimes different from the actual ones. The materials, dimensions, and the like exemplified in the following description are merely examples, and the present invention is not limited thereto and can be implemented by being appropriately modified within the range that does not change the gist thereof.

### “Solid Electrolyte Battery”

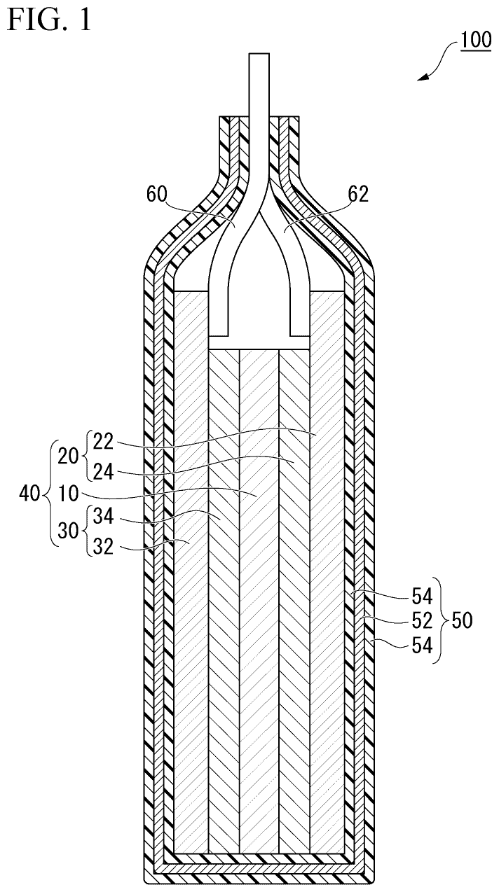

FIG. 1 is a cross-sectional schematic view of a solid electrolyte battery 100 according to the present embodiment. The solid electrolyte battery 100 shown in FIG. 1 includes a power generation element 40 and an exterior body 50. The exterior body 50 covers the periphery of the power generation element 40. The power generation element 40 is connected to outside via a pair of terminals 60 and 62 connected to the power generation element 40. In FIG. 1, a laminated battery is shown, but a wound battery may also be used. The solid electrolyte battery 100 is used, for example, as a laminate battery, a square battery, a cylindrical battery, a coin type battery, and a button-type battery. Although this is a solid battery, organic components such as liquid electrolytes may also be detected.

### <Power Generation Element>

The power generation element 40 includes the solid electrolyte layer 10, a positive electrode 20, and a negative electrode 30. The power generation element 40 performs charging or discharging through exchange of ions via the solid electrolyte layer 10 between the positive electrode 20 and the negative electrode 30 and exchange of electrons via an external circuit.

### (Solid Electrolyte Layer)

The solid electrolyte layer 10 is sandwiched between the positive electrode 20 and the negative electrode 30. The solid electrolyte layer 10 contains a solid electrolyte capable of transferring ions by an externally applied voltage. For example, solid electrolytes conduct lithium ions and inhibit transfer of electrons.

The solid electrolyte layer 10 contains, for example, a solid electrolyte. A solid electrolyte is a material that can transfer ions by applying an electric field from outside. A high ionic conductivity of a solid electrolyte facilitates smooth exchange of ions in a solid electrolyte battery, resulting in lower internal resistance.

The solid electrolyte may be in the form of a powder (particles) or in the form of a sintered body obtained by sintering a powder. In addition, the solid electrolyte may also be a molded body obtained by compressing and molding a powder, a molded body obtained by molding a mixture of a powder and a binder, and a coating film obtained by applying a coating material containing a powder, a binder, and a solvent, followed by heating the coating material to remove the solvent.

The solid electrolyte layer 10 may contain a binder, a compound, and the like in addition to the solid electrolyte. The binder may be the same as that used for the positive electrode 20 or the negative electrode 30. The compound is a material derived from raw material powder and is, for example, Li₂SO₄, ZrCl₄, P₂O₅, and PCl₅.

The solid electrolyte layer 10 contains Li, Zr, SOₓ, one or more halogens, and P. Li is a lithium ion. Zr is a zirconium ion. SOₓ is a sulfate ion. x satisfies 0<x≤4.0. Preferably, x=4.0. SOₓ is, for example, SO₃, SO₄, SO₅, SO_{3/2}, SO₂, SO_{5/2}, or SO_{7/2}. For S_{z}O_{y} such as S₂O₃ and S₄O₆, (z×SO_{y/z}, x=y/z) is used. For example, 1 mol of S₂O₃ is counted as 2 mol of SO_{1.5}. The halogens are at least one or more ions selected from the group consisting of F, Cl, Br, and I. P is a phosphorus ion.

The solid electrolyte layer 10 contains Li, Zr, SOₓ, one or more halogens, and P as main elements. The main elements are major elements confirmed in composition analysis, excluding elements mixed in as impurities. The main elements are elements that are clearly detected by composition analysis. The composition analysis is carried out, for example, by surface analysis using an electron probe microanalyzer (EPMA). The composition analysis may be performed, for example, by energy dispersive X-ray spectroscopy using a transmission electron microscope (SEM-EDS) or inductively coupled plasma mass spectrometry (ICP-MS). The main elements are, for example, elements constituting the crystal structure of the solid electrolyte. For example, the mole fraction of Li, Zr, SOₓ, one or more halogens, and P is 90% or more of the total number of moles of the solid electrolyte layer 10.

In addition, Li, Zr, SOₓ, and one or more halogens are, for example, one of the constituent elements constituting the solid electrolyte. The solid electrolyte may be crystalline or amorphous. In addition, Li, Zr, SOₓ, and one or more halogens may be contained as compounds originating from raw materials other than the solid electrolyte. For example, the solid electrolyte layer 10 may contain a composition mainly composed of Li, S, and O as a different phase other than the solid electrolyte. The composition mainly composed of Li, S, and O is, for example, Li₂SO₄. The composition mainly composed of Li, S, and O and the solid electrolyte may be in an island-like relationship, for example. For example, the composition mainly composed of Li, S, and O may be scattered within the solid electrolyte layer 10. In addition, the solid electrolyte layer 10 may contain, for example lithium oxide powder. Although not particularly limited, the content of lithium oxide powder in the solid electrolyte layer 10 may be, relative to the total mass of the solid electrolyte layer 10, 0.1 mass % to 20 mass %, 1 mass % to 15 mass %, or 2 mass % to 12 mass %.

P may be contained as one of the constituent elements constituting the solid electrolyte, or may be contained as a phosphorus compound different from the solid electrolyte. The phosphorus compound is, for example, a phosphorus oxide. The phosphorus oxide is, for example, P₂O₅.

P is contained at least in a first region of the solid electrolyte layer 10 which is in contact with the negative electrode 30. When the first region contains P, the solid electrolyte 10 is less likely to be reduced by the negative electrode 30. Although not particularly limited, in the first region, the molar ratio of P to Zr may be 0.05 to 1.0, 0.07 to 0.8, or 0.1 to 0.6.

In the solid electrolyte layer 10, the molar ratio of SOₓ to Zr is 0.25 to 3.0, and preferably 1.0 to 3.0. The molar ratio is obtained, for example, by surface analysis using an electron probe microanalyzer (EPMA). Zr is an element that forms the framework of the solid electrolyte, and determines the molar ratio of SOₓ to Zr. When the solid electrolyte layer 10 contains sulfate ions, a potential window on the reduction side of the solid electrolyte layer 10 becomes wider, and therefore, the molar ratio of SOₓ to Zr is preferably 0.25 or more, and more preferably 1.0 or more. In addition, to prevent a decrease in the ionic conductivity of the solid electrolyte layer 10 due to an excessively high content of sulfate ions, it is preferable that b in Chemical Formula (1) which will be described below be 3.0 or less.

In the solid electrolyte layer 10, the molar ratio of P to Zr is 0.02 to 0.6, and preferably 0.05 to 0.3. The molar ratio is obtained, for example, by surface analysis using an electron probe microanalyzer (EPMA). Although the reason is not clear, when a small amount of P is contained in the solid electrolyte, the solid electrolyte layer 10 becomes less likely to be reduced, and the stability of the solid electrolyte layer 10 itself with respect to the negative electrode 30 is enhanced. Therefore, the solid electrolyte layer 10 becomes stable even if a buffer layer containing a compound stable with respect to Li is not inserted between the solid electrolyte layer 10 and the negative electrode 30.

In the solid electrolyte layer 10, the molar ratio of the halogens to Zr is 3.0 to 6.1, and preferably 4.0 to 5.0. The molar ratio is obtained, for example, by surface analysis using an electron probe microanalyzer (EPMA). When the halogen is F, the solid electrolyte has a sufficiently high ionic conductivity and excellent oxidation resistance. When the halogen is Cl, the solid electrolyte has a high ionic conductivity and a good balance between oxidation resistance and reduction resistance. When the halogen is Br, the solid electrolyte has a sufficiently high ionic conductivity and a good balance between oxidation resistance and reduction resistance. When the halogen is I, the solid electrolyte has high ionic conductivity.

In the solid electrolyte layer 10, the molar ratio of Li to Zr is 0.6 to 6.0, and preferably 1.5 to 5.0. When the content of Li contained in a compound is within these ranges, the ionic conductivity of the solid electrolyte layer 10 is high.

Here, the molar ratios of Zr, SOₓ, the halogens, and Li in the solid electrolyte layer 10 refer to the molar ratios of these elements contained in the entire solid electrolyte layer 10. When the molar ratios are determined by surface analysis such as EPMA, five surfaces located at different positions in the thickness direction of the solid electrolyte layer 10 are analyzed, and the average of these measurements is calculated. For example, in each of five equally divided sections of the solid electrolyte layer 10 in the thickness direction, a 20 μm-square region overlapping when viewed from the thickness direction is set as a surface analysis region.

The solid electrolyte contained in the solid electrolyte layer 10 is, for example, a halide solid electrolyte represented by LiₐZr(SOₓ)_{b}X_{c} . . . (1). Formula (1) satisfies 0.6≤a≤6.0, 0.25≤b≤3.0, 3.0≤c≤6.1, and 0<x≤4.0. a preferably satisfies 1.2≤a≤6.0, and more preferably satisfies 1.5≤a≤5.0. b preferably satisfies 1.0≤b≤3.0. The solid electrolyte contained in the solid electrolyte layer 10 may be a compound represented by Formula (1) in which a part of the compound is substituted with phosphorus.

### (Positive Electrode)

As shown in FIG. 1, the positive electrode 20 has a plate-like (foil-like) positive electrode current collector 22 and a positive electrode active material layer 24. The positive electrode active material layer 24 comes into contact with at least one surface of the positive electrode current collector 22.

The positive electrode current collector 22 may be an electron-conductive material that withstands oxidation during charging and is resistant to corrosion. The positive electrode current collector 22 is, for example, a metal such as aluminum, stainless steel, nickel, or titanium, or a conductive resin. The positive electrode current collector 22 may be in powder, foil, punched, or expanded form.

The positive electrode active material layer 24 contains a positive electrode active material and as necessary, a solid electrolyte, a binder, and a conductive assistant.

The positive electrode active material is not particularly limited as long as it is capable of reversibly progressing lithium ion occlusion/release and insertion/desorption (intercalation/deintercalation), and positive electrode active materials used in well-known solid electrolyte batteries can be used. Examples of positive electrode active materials include lithium-containing metal oxides and lithium-containing metal phosphorus oxides.

Lithium-containing metal oxides include, for example, lithium cobaltate (LiCoO₂), lithium nickelate (LiNiO₂), lithium manganese spinel (LiMn₂O₄), and composite metal oxides represented by General Formula: LiNiₓCo_{y}Mn_{z}O₂ (x+y+z=1), lithium vanadium compounds (LiVOPO₄, Li₃V₂(PO₄)₃), olivine-type LiMPO₄ (where M indicates at least one selected from Co, Ni, Mn, and Fe), and lithium titanate (Li₄Ti₅O₁₂).

In addition, the positive electrode active material may also be lithium-free. Examples of positive electrode active materials include lithium-free metal oxides (such as MnO₂ and V₂O₅), lithium-free metal sulfides (such as MoS₂), and lithium-free fluorides (such as FeF₃ and VF₃). When using a positive electrode active material that does not contain lithium, a negative electrode is doped with lithium ions in advance, or a negative electrode containing lithium ions is used.

The solid electrolyte contained in the positive electrode 20 is, for example, the same as the solid electrolyte contained in the solid electrolyte layer 10. When the solid electrolyte layer 10, the positive electrode 20, and the negative electrode 30 contain the same solid electrolyte, the manufacture of the solid electrolyte battery 100 becomes easier. The solid electrolyte contained in the positive electrode 20 may be different from, for example, the solid electrolyte contained in the solid electrolyte layer 10.

The positive electrode 20 may contain Li, Zr, SOₓ, one or more halogens, and P. The positive electrode 20 may contain, for example, P and a solid electrolyte containing Li, Zr, SOₓ, and one or more halogens. P may be contained as one of the constituent elements constituting the solid electrolyte, or may be contained as a phosphorus compound different from the solid electrolyte. The phosphorus compound is, for example, a phosphorus oxide. The phosphorus oxide is, for example, P₂O₅. The positive electrode 20 may include, for example, lithium oxide powder.

In the positive electrode 20, the molar ratio of SOₓ to Zr is, for example, 0.25 to 3.0, and preferably 1.0 to 3.0. In the positive electrode 20, the molar ratio of P to Zr is, for example, 0.02 to 0.6, and preferably 0.05 to 0.3. In the positive electrode 20, the molar ratio of the halogens to Zr is, for example, 3.0 to 6.1, and preferably 4.0 to 5.0. In the positive electrode 20, the molar ratio of Li to Zr is 0.6 to 6.0, and preferably 1.5 to 5.0.

The content of a solid electrolyte in the positive electrode active material layer 24 is not particularly limited, but it is preferably 1 mass % to 50 mass % and more preferably 5 mass % to 30 mass % based on the total mass of a positive electrode active material, the solid electrolyte, a conductive assistant, and a binder.

A binder binds a positive electrode active material, a solid electrolyte, and a conductive assistant together in the positive electrode active material layer 24, and also firmly bonds the positive electrode active material layer 24 to the positive electrode current collector 22. The positive electrode active material layer 24 preferably contains a binder. The binder is preferably oxidation resistant and has favorable adhesiveness.

Examples of binders used in the positive electrode active material layer 24 include polyvinylidene fluoride (PVDF) or copolymers thereof, polytetrafluoroethylene (PTFE), polyamide (PA), polyimide (PI), polyamideimide (PAI), polybenzimidazole (PBI), polyethersulfone (PES), polyacrylic acid (PA) and copolymers thereof, metal ion cross-linked polyacrylic acid (PA) and copolymers thereof, maleic anhydride-grafted polypropylene (PP), maleic anhydride-grafted polyethylene (PE), and mixtures thereof. Among these, PVDF is particularly preferably used as a binder.

The content of a binder in the positive electrode active material layer 24 is not particularly limited, but it is preferably 0.3 mass % to 10 mass % and more preferably 0.3 mass % to 5 mass % based on the total mass of a positive electrode active material, a solid electrolyte, a conductive assistant, and the binder. If the amount of binder is too small, it tends not to be possible to form a positive electrode 20 with sufficient adhesive strength. Conversely, too much binder tends to make it difficult to obtain sufficient volume or mass energy density, since common binders are electrochemically inert and do not contribute to discharge capacity.

The conductive assistant improves electron conductivity of the positive electrode active material layer 24. Well-known binders can be used as the conductive assistant. Conductive assistants are, for example, carbon materials such as carbon black, graphite, carbon nanotubes, and graphene, metals such as aluminum, copper, nickel, stainless steel, iron, and amorphous metals, conductive oxides such as ITO, or mixtures thereof. The conductive assistant may be in powder or fiber form.

The content of a conductive assistant in the positive electrode active material layer 24 is not particularly limited. When a conductive assistant is incorporated, the mass proportion of the conductive assistant is preferably 0.5 mass % to 20 mass % and more preferably 1 mass % to 5 mass % based on the total mass of a positive electrode active material, a solid electrolyte, the conductive assistant, and a binder.

### (Negative Electrode)

As shown in FIG. 1, the negative electrode 30 has a negative electrode current collector 32 and a negative electrode active material layer 34. The negative electrode active material layer 34 comes into contact with the negative electrode current collector 32. The negative electrode active material layer 34 is provided between the negative electrode current collector 32 and the solid electrolyte layer 10.

The negative electrode current collector 32 may have electron conductivity. The negative electrode current collector 32 is, for example, a metal such as copper, aluminum, nickel, stainless steel, or iron, or a conductive resin. The negative electrode current collector 32 may be in powder, foil, punched, or expanded form.

The negative electrode active material layer 34 contains a negative electrode active material and as necessary, a solid electrolyte, a binder, and a conductive assistant.

The negative electrode active material is not particularly limited as long as it is capable of reversibly progressing occlusion and release of lithium ions and insertion and desorption of lithium ions. Negative electrode active materials used in well-known solid electrolyte batteries can be used as the negative electrode active material. The negative electrode active material layer 34 may contain, for example, lithium metal as a negative electrode active material, or may contain any one or more selected from graphite, silicon, tin, and silver. In addition, the graphite, silicon, tin, and silver may be pre-alloyed. Although not particularly limited, the content of lithium metal in the negative electrode active material layer 34 may be, relative to the total mass of the negative electrode active material layer 34, 70 mass % to 100 mass %, 80 mass % to 100 mass %, or 90 mass % to 100 mass %. In addition, although not particularly limited, when lithium metal is selected as the negative electrode active material, the thickness of the negative electrode active material layer 34 may be 1 μm to 50 μm, 3 μm to 20 μm, or 5 μm to 15 μm. In addition, although not particularly limited, the content of any one or more selected from graphite, silicon, tin, and silver in the negative electrode active material layer 34 may be, relative to the total mass of the negative electrode active material layer 34, 20 mass % to 100 mass %, 30 mass % to 100 mass %, or 50 mass % to 85 mass %.

In addition, the negative electrode 30 may have only the negative electrode current collector 32, in which lithium metal precipitates between the negative electrode current collector 32 and the solid electrolyte layer 10 during charging, and the lithium metal dissolves during discharging.

A solid electrolyte contained in the negative electrode 30 is, for example, the solid electrolyte described above. The solid electrolyte contained in the positive electrode 20 may be different from, for example, the solid electrolyte contained in the solid electrolyte layer 10.

The negative electrode 30 may contain Li, Zr, SOₓ, one or more halogens, and P. The negative electrode 30 may contain, for example, P and a solid electrolyte containing Li, Zr, SOₓ, and one or more halogens. When the negative electrode 30 contains a predetermined amount of phosphorus, it is possible to prevent the solid electrolyte from being reduced within the negative electrode 30. P may be contained as one of the constituent elements constituting the solid electrolyte, or may be contained as a phosphorus compound different from the solid electrolyte. The phosphorus compound is, for example, a phosphorus oxide. The phosphorus oxide is, for example, P₂O₅. The negative electrode 30 may include, for example, lithium oxide powder. The content of lithium oxide powder in the negative electrode 30 may be, relative to the total mass of the negative electrode 30, 0.2 mass % to 10 mass %, 0.5 mass % to 8.0 mass %, or 1.0 mass % to 5.0 mass %.

In the negative electrode 30, the molar ratio of SOₓ to Zr is, for example, 0.25 to 3.0, and preferably 1.0 to 3.0. In the negative electrode 30, the molar ratio of P to Zr is, for example, 0.02 to 0.6, and preferably 0.05 to 0.3. In the negative electrode 30, the molar ratio of the halogens to Zr is, for example, 3.0 to 6.1, and preferably 4.0 to 5.0. In the negative electrode 30, the molar ratio of Li to Zr is 0.6 to 6.0, and preferably 1.5 to 5.0.

A binder and a conductive assistant contained in the negative electrode 30 are the same as the binder and the conductive assistant contained in the positive electrode 20.

### <Exterior Body>

The exterior body 50 internally stores the power generation element 40. The exterior body 50 prevents moisture or the like from entering the interior from outside. The exterior body 50 includes, for example, a metal foil 52 and a resin layer 54 laminated on each surface of the metal foil 52, as shown in FIG. 1. The exterior body 50 is a metal laminated film obtained by coating both sides of the metal foil 52 with the resin layer 54.

The metal foil 52 is, for example, aluminum foil or stainless steel foil. A resin film such as polypropylene can be used as the resin layer 54, for example. The material constituting the resin layer 54 may be different between the inner and outer resin layers. For example, polymers, such as polyethylene terephthalate (PET) and polyamide (PA), having a high melting point can be used as the outer material, and polyethylene (PE), polypropylene (PP), and the like can be used as the inner material.

### <Terminals>

Terminals 60 and 62 are respectively connected to the negative electrode 30 and the positive electrode 20. The terminal 62 connected to the positive electrode 20 is a positive electrode terminal, and the terminal 60 connected to the negative electrode 30 is a negative electrode terminal. The terminals 60 and 62 are responsible for electrical connection with outside. The terminals 60 and 62 are made of conductive materials such as aluminum, nickel, and copper. The connection method may be welding or screwing. The terminals 60 and 62 are preferably protected by insulating tape to prevent a short circuit.

### (Method for Manufacturing Solid Electrolyte)

The solid electrolyte of the present embodiment is prepared by a first method or a second method. The first method is a method in which Li₂SO₄ and ZrCl₄ are reacted and synthesized, followed by re-synthesis after addition of a phosphorus compound. The second method is a method in which Li₂SO₄, ZrCl₄, and a phosphorus compound are simultaneously synthesized.

First, the first method will be specifically described. First, Li₂SO₄ and ZrCl₄ which are raw materials are mixed together at a predetermined molar ratio and charged into a synthesis pot.

Next, while the synthesis pot is air-cooled, the mixture mixed at a predetermined molar ratio is synthesized by a mechanochemical method. A mechanochemical reaction at this time is carried out, for example, at a rotation frequency of 300 rpm for 7 hours. Then, the first synthesis product after the reaction is taken out from the synthesis pot.

Next, the first synthesis product and a phosphorus compound are mixed at a predetermined molar ratio and charged into a synthesis pot. The phosphorus compound is, for example, P₂O₅ or PCl₅. Next, while the synthesis pot is air-cooled, the mixture mixed at a predetermined molar ratio is synthesized by a mechanochemical method. A mechanochemical reaction at this time is carried out, for example, at a rotation frequency of 300 rpm for 30 minutes. Then, the second synthesis product after the reaction is taken out from the synthesis pot. This second synthesis product becomes the solid electrolyte.

Next, the second method will be specifically described. In the second method, Li₂SO₄, ZrCl₄, and a phosphorus compound which are raw materials are mixed together at a predetermined molar ratio and charged into a synthesis pot. The phosphorus compound is, for example, P₂O₅ or PCl₅.

Next, while the synthesis pot is air-cooled, the mixture mixed at a predetermined molar ratio is synthesized by a mechanochemical method. A mechanochemical reaction at this time is carried out, for example, at a rotation frequency of 300 rpm for 7 hours. Then, the synthesis product after the reaction is taken out from the synthesis pot. This synthesis product becomes the solid electrolyte.

The solid electrolyte can be prepared by either the first method or the second method. When the solid electrolyte is prepared by the first method, the phosphorus compound added as a raw material tends to remain as it is in the solid electrolyte layer 10 more often than when the solid electrolyte is prepared by the second method.

### [Method for Manufacturing Solid Electrolyte Battery]

A positive electrode is manufactured by applying a paste containing a positive electrode active material on the positive electrode current collector 22 and drying it to form the positive electrode active material layer 24. The solid electrolyte described above may be added to the paste containing the positive electrode active material.

Subsequently, the negative electrode 30 is prepared. A negative electrode is manufactured by applying a paste containing a negative electrode active material on the negative electrode current collector 32 and drying it to form the negative electrode active material layer 34. The solid electrolyte described above may be added to the paste containing the negative electrode active material.

The power generation element 40 can be manufactured, for example, through a powder molding method. A guide with a hole portion is placed over the positive electrode 20 and filled with a solid electrolyte. Thereafter, the surface of the solid electrolyte is smoothed, and the negative electrode 30 is superposed on top of the solid electrolyte. As a result, the solid electrolyte is sandwiched between the positive electrode 20 and the negative electrode 30. Thereafter, the solid electrolyte is then press-molded by applying a pressure to the positive electrode 20 and the negative electrode 30. By performing press-molding, a laminate is obtained in which the positive electrode 20, the solid electrolyte layer 10, and the negative electrode 30 are laminated in this order.

Next, external terminals are respectively welded to the positive electrode current collector 22 of the positive electrode 20 and the negative electrode current collector 32 of the negative electrode 30, which form the laminate, through a well-known method to electrically connect the positive electrode current collector 22 or the negative electrode current collector 32 to each external terminal. Thereafter, the laminate connected to the external terminals is stored in the exterior body 50, and an opening portion of the exterior body 50 is sealed through heat-sealing. A solid electrolyte battery 100 of the present embodiment is obtained through the above-described process.

The solid electrolyte battery 100 according to the present embodiment contains a predetermined amount of P in the first region where the solid electrolyte layer 10 is in contact with the negative electrode 30. Although the reason is not clear, when a small amount of P is contained in the solid electrolyte, the solid electrolyte layer 10 becomes less likely to be reduced, and the stability of the solid electrolyte layer 10 itself with respect to the negative electrode 30 is enhanced. Therefore, the solid electrolyte layer 10 becomes stable even if a buffer layer containing a compound stable with respect to Li is not inserted between the solid electrolyte layer 10 and the negative electrode 30.

The embodiment of the present invention has been described in detail above with reference to the drawings. However, each configuration and combination of each embodiment is merely an example, and addition, omission, replacement, and other modifications of the configuration can be made within the scope not departing from the gist of the present invention.

### EXAMPLES

### Example 1

A solid electrolyte was prepared by the first method. First, in a glove box with a dew point of about −75° C., lithium sulfate (Li₂SO₄) and zirconium chloride (ZrCl₄) were weighed out as raw material powders at a molar ratio of 1:1. Subsequently, the raw material powders were placed in a sealed zirconia container for a planetary ball mill in which 5 mm-diameter zirconia balls had been placed in advance. Next, the sealed container was covered with a lid, the lid was screwed onto the container body, and the space between the lid and the container was further sealed with polyimide tape. The polyimide tape is effective in blocking moisture. Next, the sealed zirconia container was set in the planetary ball mill. The number of rotations was set to 300 rpm, the number of revolutions was set to 300 rpm, and the rotation direction and the revolution direction were set in opposite directions to cause a mechanochemical reaction for 7 hours to prepare a first synthesis product.

Next, P₂O₅ was added to the first synthesis product. The molar ratio of P₂O₅ to lithium sulfate was 0.07. The number of rotations was set to 300 rpm, the number of revolutions was set to 300 rpm, and the rotation direction and the revolution direction were set in opposite directions to cause a mechanochemical reaction for 30 minutes to prepare a solid electrolyte.

The composition of the solid electrolyte thus prepared was analyzed by surface analysis using an electron probe microanalyzer (EPMA). The molar ratio of Li to Zr in the solid electrolyte was 2.0, the molar ratio of SO₄ to Zr was 1.0, the molar ratio of P to Zr was 0.14, and the molar ratio of Cl to Zr was 4.0. P₂O₅ was also confirmed in the solid electrolyte.

### [Measurement of Ionic Conductivity]

Subsequently, in a glove box with a dew point of about −70° C. with argon gas circulating, the solid electrolyte powder was filled into a press-molding die and press-molded with a weight of about 30 KN to manufacture an ionic conductivity measurement cell.

The press-molding die consists of a polyether ether ketone (PEEK) cylinder with a diameter of 10 mm and upper and lower punches which have a diameter of 9.99 mm and are made of SKD11 material.

Thereafter, a stainless steel disk and a Teflon (registered trademark) disk with a diameter of 50 mm, a thickness of 5 mm, and screw holes in four locations were prepared to set a press-molding die as follows. A stainless steel disk, a Teflon (registered trademark) disk, a press-molded die, a Teflon (registered trademark) disk, and a stainless steel disk were stacked in this order, and four screws were tightened with a torque of about 3 N·m. In addition, screws were inserted into the screw holes provided on the side surfaces of the upper and lower punches to serve as external connection terminals.

The external connection terminals were connected to a potentiostat (VersaSTAT3 manufactured by Princeton Applied Research) equipped with a frequency response analyzer to measure ionic conductivity using an impedance measurement method. Measurement was performed in a measurement frequency range of 1 MHz to 0.1 Hz, an amplitude of 10 mV, and a temperature of 25° C. The ionic conductivity of the solid electrolyte of Example 1 was 0.50 mS/cm.

### [Charge-Discharge Evaluation]

In a glove box, 100 mg of the solid electrolyte was preliminarily pressed at 0.6 tons for 1 minute, and then finally pressed at 2 tons for 1 minute to prepare a measurement sample. The measurement sample was then sandwiched between Li foils, and the outer side of the Li foils was further sandwiched between Cu foils. These were restrained at 3 Nm using a restraining jig and sealed in an aluminum pouch with terminals. By this procedure, a Li symmetric cell for charge-discharge evaluation was prepared.

Next, the Li symmetric cell was charged and discharged in a temperature environment of 25° C. The charge rate and discharge rate were set to 0.1 C (a current value at which charging or discharging is completed in 10 hours when charging or discharging at a constant current of 1 mA is performed at 25° C.), and a charge-discharge test was performed at 100 cycles per hour. Then, the maximum voltage of the Li symmetric cell after the elapse of 100 hours was measured. The voltage of the Li symmetric cell of Example 1 after the elapse of 100 hours was 17.7 mV.

### Example 2

Example 2 is different from Example 1 in that the phosphorus compound was changed from P₂O₅ to PCl₅. In Example 2, the ionic conductivity and the voltage after the elapse of 100 hours were measured in the same manner as in Example 1.

The composition of the solid electrolyte thus prepared was analyzed by surface analysis using an electron probe microanalyzer (EPMA). The molar ratio of Li to Zr in the solid electrolyte was 2.0, the molar ratio of SO₄ to Zr was 1.0, the molar ratio of P to Zr was 0.07, and the molar ratio of Cl to Zr was 4.35. PCl₅ was also confirmed in the solid electrolyte.

### Example 3

Example 3 is different from Example 1 in that the solid electrolyte was prepared by the second method. In Example 3, the ionic conductivity and the voltage after the elapse of 100 hours were measured in the same manner as in Example 1.

First, in a glove box with a dew point of about −75° C., zirconium chloride (ZrCl₄), lithium sulfate (Li₂SO₄), and phosphorus pentoxide (P₂O₅) were weighed out as raw material powders at a molar ratio of 1:1:0.07. Subsequently, the raw material powders were placed in a sealed zirconia container for a planetary ball mill in which 5 mm-diameter zirconia balls had been placed in advance. Next, the sealed container was covered with a lid, the lid was screwed onto the container body, and the space between the lid and the container was further sealed with polyimide tape. The polyimide tape is effective in blocking moisture. Next, the sealed zirconia container was set in the planetary ball mill. The number of rotations was set to 300 rpm, the number of revolutions was set to 300 rpm, and the rotation direction and the revolution direction were set in opposite directions to cause a mechanochemical reaction for 7 hours to prepare a solid electrolyte.

### Examples 4 to 7

Examples 4 to 7 are different from Example 3 in that the molar ratio of phosphorus pentoxide (P₂O₅) when preparing the solid electrolyte was changed. In Examples 4 to 7, the ionic conductivity and the voltage after the elapse of 100 hours were measured in the same manner as in Example 1.

### Examples 8 to 11

Examples 8 to 11 are different from Example 3 in that the molar ratio of lithium sulfate (Li₂SO₄) when preparing the solid electrolyte was changed. In Examples 8 to 11, the ionic conductivity and the voltage after the elapse of 100 hours were measured in the same manner as in Example 1.

### Examples 12 and 13

Examples 12 and 13 are different from Example 3 in that LiCl was further added when preparing the solid electrolyte. In Example 12, zirconium chloride (ZrCl₄), lithium sulfate (Li₂SO₄), phosphorus pentoxide (P₂O₅), and lithium chloride (LiCl) were weighed out as raw material powders at a molar ratio of 1:0.6:0.07:1.0. In Example 13, zirconium chloride (ZrCl₄), lithium sulfate (Li₂SO₄), phosphorus pentoxide (P₂O₅), and lithium chloride (LiCl) were weighed out as raw material powders at a molar ratio of 1:0.25:0.07:1.0. In Examples 12 to 13, the ionic conductivity and the voltage after the elapse of 100 hours were measured in the same manner as in Example 1.

### Example 14

Example 14 is different from Example 1 in that lithium oxide powder was added after the synthesis of the solid electrolyte. Specifically, based on the second method, zirconium chloride (ZrCl₄), lithium sulfate (Li₂SO₄), and phosphorus pentoxide (P₂O₅) were subjected to a mechanochemical reaction for 7 hours, after which lithium oxide powder was added and mixed using a planetary ball mill for about 10 minutes. Hereinafter, this method will be referred to as a third method. In Example 14, the ionic conductivity and the voltage after the elapse of 100 hours were measured in the same manner as in Example 1.

### Comparative Example 1

Comparative Example 1 is different from Example 3 in that phosphorus pentoxide was not added to the raw materials. In Comparative Example 1, the ionic conductivity and the voltage after the elapse of 100 hours were measured in the same manner as in Example 1.

### Comparative Examples 2 to 4

Comparative Examples 2 to 4 are different from Example 3 in that the molar ratio of phosphorus pentoxide (P₂O₅) when preparing the solid electrolyte was changed. In Comparative Examples 2 to 4, the ionic conductivity and the voltage after the elapse of 100 hours were measured in the same manner as in Example 1.

### Comparative Examples 5 and 6

Comparative Examples 5 and 6 are different from Example 3 in that, when preparing the solid electrolyte, lithium sulfate (Li₂SO₄) was replaced with lithium oxide (Li₂O) and the molar ratio of the raw materials was changed. In Comparative Example 5, zirconium chloride (ZrCl₄), lithium oxide (Li₂O), and phosphorus pentoxide (P₂O₅) were weighed out as raw material powders at a molar ratio of 1:1:0.1. In Comparative Example 6, zirconium chloride (ZrCl₄), lithium oxide (Li₂O), and phosphorus pentoxide (P₂O₅) were weighed out as raw material powders at a molar ratio of 1:1:0.3. In Comparative Examples 5 and 6, the ionic conductivity and the voltage after the elapse of 100 hours were measured in the same manner as in Example 1.

### Comparative Examples 7 and 8

Comparative Examples 7 and 8 are different from Example 3 in that, when preparing the solid electrolyte, the raw materials and their molar ratios were changed. In Comparative Example 7, zirconium chloride (ZrCl₄) and lithium oxide (Li₂O) were weighed out as raw material powders at a molar ratio of 1:1. In Comparative Example 8, zirconium chloride (ZrCl₄) and lithium phosphate (Li₃PO₄) were weighed out as raw material powders at a molar ratio of 1:1. In Comparative Examples 7 and 8, the ionic conductivity and the voltage after the elapse of 100 hours were measured in the same manner as in Example 1.

The production conditions for the solid electrolytes of Examples 1 to 14 and Comparative Examples 1 to 8 are summarized in Table 1 below. In addition, the evaluation results of the solid electrolytes of Examples 1 to 14 and Comparative Examples 1 to 8 are summarized in Table 2 below. In Table 2, “1000<” indicates that the voltage was greater than 1000 mV.

TABLE 1

| | Raw material ratio | | | | | | | | |
|---|---|---|---|---|---|---|---|---|---|
| | Raw | Molar | Raw | Molar | Raw | Molar | Raw | Molar | Production |
| | Material 1 | ratio | Material 2 | ratio | Material 3 | ratio | Material 4 | ratio | method |
| Example 1 | ZrCl₄ | 1 | Li₂SO₄ | 1 | P₂O₅ | 0.07 | | | First |
| | | | | | | | | | method |
| Example 2 | ZrCl₄ | 1 | Li₂SO₄ | 1 | PCl₅ | 0.07 | | | First |
| | | | | | | | | | method |
| Example 3 | ZrCl₄ | 1 | Li₂SO₄ | 1 | P₂O₅ | 0.07 | | | Second |
| | | | | | | | | | method |
| Example 4 | ZrCl₄ | 1 | Li₂SO₄ | 1 | P₂O₅ | 0.14 | | | Second |
| | | | | | | | | | method |
| Example 5 | ZrCl₄ | 1 | Li₂SO₄ | 1 | P₂O₅ | 0.23 | | | Second |
| | | | | | | | | | method |
| Example 6 | ZrCl₄ | 1 | Li₂SO₄ | 1 | P₂O₅ | 0.29 | | | Second |
| | | | | | | | | | method |
| Example 7 | ZrCl₄ | 1 | Li₂SO₄ | 1 | P₂O₅ | 0.015 | | | Second |
| | | | | | | | | | method |
| Example 8 | ZrCl₄ | 1 | Li₂SO₄ | 0.7 | P₂O₅ | 0.07 | | | Second |
| | | | | | | | | | method |
| Example 9 | ZrCl₄ | 1 | Li₂SO₄ | 0.3 | P₂O₅ | 0.07 | | | Second |
| | | | | | | | | | method |
| Example 10 | ZrCl₄ | 1 | Li₂SO₄ | 2 | P₂O₅ | 0.07 | | | Second |
| | | | | | | | | | method |
| Example 11 | ZrCl₄ | 1 | Li₂SO₄ | 3 | P₂O₅ | 0.07 | | | Second |
| | | | | | | | | | method |
| Example 12 | ZrCl₄ | 1 | Li₂SO₄ | 0.6 | P₂O₅ | 0.07 | LiCl | 1 | Second |
| | | | | | | | | | method |
| Example 13 | ZrCl₄ | 1 | Li₂SO₄ | 0.25 | P₂O₅ | 0.07 | LiCl | 1 | Second |
| | | | | | | | | | method |
| Example 14 | ZrCl₄ | 1 | Li₂SO₄ | 1 | P₂O₅ | 0.07 | Li₂O | 0.2 | Third |
| | | | | | | | | | method |
| Comparative | ZrCl₄ | 1 | Li₂SO₄ | 1 | | | | | Second |
| Example 1 | | | | | | | | | method |
| Comparative | ZrCl₄ | 1 | Li₂SO₄ | 1 | P₂O₅ | 0.31 | | | Second |
| Example 2 | | | | | | | | | method |
| Comparative | ZrCl₄ | 1 | Li₂SO₄ | 1 | P₂O₅ | 0.34 | | | Second |
| Example 3 | | | | | | | | | method |
| Comparative | ZrCl₄ | 1 | Li₂SO₄ | 1 | P₂O₅ | 0.5 | | | Second |
| Example 4 | | | | | | | | | method |
| Comparative | ZrCl₄ | 1 | Li₂O | 1 | P₂O₅ | 0.1 | | | Second |
| Example 5 | | | | | | | | | method |
| Comparative | ZrCl₄ | 1 | Li₂O | 1 | P₂O₅ | 0.3 | | | Second |
| Example 6 | | | | | | | | | method |
| Comparative | ZrCl₄ | 1 | Li₂O | 1 | | | | | Second |
| Example 7 | | | | | | | | | method |
| Comparative | ZrCl₄ | 1 | Li₃PO₄ | 1 | | | | | Second |
| Example 8 | | | | | | | | | method |

TABLE 2

| | Solid electrolyte layer | | | | Presence | Presence | | |
|---|---|---|---|---|---|---|---|---|
| | Molar | Molar | Molar | Molar | or absence | or absence | Ionic | Overvoltage |
| | ratio | ratio | ratio | ratio | of phosphorus | of lithium | conductivity | increase |
| | Li/Zr | SOₓ/Zr | P/Zr | Cl/Zr | compound | oxide | (mS/cm) | (mV) |
| Example 1 | 2 | 1 | 0.14 | 4 | Present | Absent | 0.5 | 17.7 |
| Example 2 | 2 | 1 | 0.07 | 4.35 | Present | Absent | 0.62 | 43.8 |
| Example 3 | 2 | 1 | 0.14 | 4 | Absent | Absent | 0.77 | 12.5 |
| Example 4 | 2 | 1 | 0.28 | 4 | Absent | Absent | 0.35 | 13.5 |
| Example 5 | 2 | 1 | 0.34 | 4 | Absent | Absent | 0.15 | 70.5 |
| Example 6 | 2 | 1 | 0.38 | 4 | Absent | Absent | 0.1 | 90.5 |
| Example 7 | 2 | 1 | 0.03 | 4 | Absent | Absent | 1.0 | 65.5 |
| Example 8 | 1.4 | 0.7 | 0.14 | 4 | Absent | Absent | 0.72 | 85.5 |
| Example 9 | 0.6 | 0.3 | 0.14 | 4 | Absent | Absent | 0.81 | 88.8 |
| Example 10 | 4 | 2 | 0.14 | 4 | Absent | Absent | 0.45 | 48.3 |
| Example 11 | 6 | 3 | 0.14 | 4 | Absent | Absent | 0.3 | 55.7 |
| Example 12 | 2.2 | 0.6 | 0.14 | 5 | Absent | Absent | 0.78 | 77.6 |
| Example 13 | 1.5 | 0.25 | 0.14 | 5 | Absent | Absent | 0.8 | 67.8 |
| Example 14 | 2.4 | 1 | 0.14 | 4 | Absent | Present | 0.75 | 30.7 |
| Comparative | 2 | 1 | 0 | 4 | Absent | Absent | 1.8 | 326 |
| Example 1 | | | | | | | | |
| Comparative | 2 | 1 | 0.62 | 4 | Absent | Absent | 0.005 | 270 |
| Example 2 | | | | | | | | |
| Comparative | 2 | 1 | 0.68 | 4 | Absent | Absent | 0.001 | 350 |
| Example 3 | | | | | | | | |
| Comparative | 2 | 1 | 1 | 4 | Absent | Absent | 0.001 | 550 |
| Example 4 | | | | | | | | |
| Comparative | 2 | 1 | 0.2 | 4 | Absent | Present | 1.3 | 1000< |
| Example 5 | | | | | | | | |
| Comparative | 2 | 0 | 0.6 | 4 | Absent | Present | 0.42 | 1000< |
| Example 6 | | | | | | | | |
| Comparative | 2 | 0 | 0 | 4 | Absent | Present | 3 | 1000< |
| Example 7 | | | | | | | | |
| Comparative | 3 | 0 | 1 | 4 | Absent | Absent | 1.5 | 1000< |
| Example 8 | | | | | | | | |

### Example 15

In Example 15, a full cell was manufactured in a glove box with a dew point of about −70° C. The full cell was manufactured using a pellet making tool. The pellet making tool has a polyether ether ketone (PEEK) holder with a diameter of 10 mm and an upper punch and a lower punch which have a diameter of 9.99 mm. The material of the upper and lower punches is die steel (SKD11 material).

The lower punch was inserted into the PEEK holder of the pellet making tool, and 50 mg of a solid electrolyte was placed on top of the lower punch. The solid electrolyte used was the same as that used in Example 1. Next, the upper punch was inserted onto the solid electrolyte, and the solid electrolyte was pressed with a press under a load of 0.6 tons for 1 minute.

Next, the lower punch was pulled out and 15 mg of a negative electrode mixture was placed on top of the solid electrolyte, and a Cu foil was placed thereon. Next, the lower punch was pressed against the Cu foil, and the foil was pressed with a press under a load of 0.6 tons for 1 minute. The negative electrode mixture contains graphite, the solid electrolyte of Example 1, and a conductive assistant. Graphite is the negative electrode active material.

Next, the upper punch was removed and 15 mg of a positive electrode mixture was placed on top of the solid electrolyte layer, and an Al foil was placed thereon. Next, the upper punch was pressed against the Al foil, and the foil was pressed with a press under a load of 0.6 tons for 1 minute. The positive electrode mixture contains LiCoO₂, a halide solid electrolyte made of Li₂ZrCl₆ (LZC), and a conductive assistant.

By the above-described procedure, a solid electrolyte battery was manufactured in which the negative electrode mixture layer, the solid electrolyte layer, and the positive electrode mixture layer were laminated in this order. Then, the initial efficiency of the manufactured solid electrolyte battery was measured. For the initial efficiency, charging was performed at a constant current rate of 0.1 C to 4.2 V in a constant temperature chamber (manufactured by Espec Corp.) at 25° C. using a charge-discharge test device (manufactured by Hokuto Denko Corporation), followed by discharging at a constant current rate of 0.1 C. The initial efficiency was calculated according to “Initial efficiency=First discharge capacity/First charge capacity×100.”

### Examples 16 to 27

Examples 16 to 27 are different from Example 15 in that the type of the solid electrolyte contained in the negative electrode mixture was changed. The initial efficiency of each solid electrolyte battery was measured while keeping the other conditions the same as in Example 15.

### Example 28

Example 28 is different from Example 15 in that the solid electrolyte contained in the positive electrode mixture was the solid electrolyte of Example 1. The initial efficiency of the solid electrolyte battery was measured while keeping the other conditions the same as in Example 15.

### Examples 29 and 30

Examples 29 and 30 are different from Example 17 in that the type of the negative electrode active material contained in the negative electrode mixture was changed. The initial efficiency of each solid electrolyte battery was measured while keeping the other conditions the same as in Example 17.

### Example 31

Example 31 is different from Example 15 in that the negative electrode mixture contains only metallic Li. The initial efficiency of each solid electrolyte battery was measured while keeping the other conditions the same as in Example 15.

### Example 32

Example 32 is different from Example 15 in that no negative electrode mixture was provided. The initial efficiency of the solid electrolyte battery was measured while keeping the other conditions the same as in Example 15. In Example 32, metallic lithium precipitated between the Cu foil and the solid electrolyte layer during charging, and the metallic lithium dissolved during discharging.

### Comparative Examples 9 to 15

Comparative Examples 9 to 15 are different from Example 15 in that the type of the solid electrolyte of the solid electrolyte layer and the type of the solid electrolyte contained in the negative electrode mixture were changed. The initial efficiency of each solid electrolyte battery was measured while keeping the other conditions the same as in Example 15.

### Comparative Examples 16 to 18

Comparative Examples 16 to 18 are different from Comparative Example 9 in that the type of the negative electrode active material was changed. The initial efficiency of each solid electrolyte battery was measured while keeping the other conditions the same as in Example 9.

### Comparative Examples 19 and 20

Comparative Examples 19 and 20 are different from Comparative Example 18 in that the type of the solid electrolyte of the solid electrolyte layer was changed. The initial efficiency of each solid electrolyte battery was measured while keeping the other conditions the same as in Example 18.

### Comparative Example 21

Comparative Example 21 is different from Comparative Example 9 in that no negative electrode mixture was provided. The initial efficiency of the solid electrolyte battery was measured while keeping the other conditions the same as in Example 9. In Comparative Example 21, metallic lithium precipitated between the Cu foil and the solid electrolyte layer during charging, and the metallic lithium dissolved during discharging.

The measurement results of the solid electrolyte batteries of Examples 15 to 32 and Comparative Examples 9 to 21 are summarized in Table 3. In addition, Table 4 summarizes the production conditions of the solid electrolytes contained in the negative electrode active materials, and Table 5 summarizes the evaluation results of the solid electrolytes contained in the negative electrode active materials.

TABLE 3

| | Negative electrode | | Positive electrode | | |
|---|---|---|---|---|---|
| | Negative electrode | Solid electrolyte | Positive electrode | Solid | Initial |
| | active material | layer | active material | electrolyte | efficiency (%) |
| Example 15 | Graphite | Example 1 | LiCoO₂ | LZC | 91 |
| Example 16 | Graphite | | LiCoO₂ | LZC | 92 |
| Example 17 | Graphite | | LiCoO₂ | LZC | 89 |
| Example 18 | Graphite | | LiCoO₂ | LZC | 81 |
| Example 19 | Graphite | | LiCoO₂ | LZC | 81 |
| Example 20 | Graphite | | LiCoO₂ | LZC | 82 |
| Example 21 | Graphite | | LiCoO₂ | LZC | 81 |
| Example 22 | Graphite | | LiCoO₂ | LZC | 83 |
| Example 23 | Graphite | | LiCoO₂ | LZC | 86 |
| Example 24 | Graphite | | LiCoO₂ | LZC | 81 |
| Example 25 | Graphite | | LiCoO₂ | LZC | 82 |
| Example 26 | Graphite | | LiCoO₂ | LZC | 81 |
| Example 27 | Graphite | | LiCoO₂ | LZC | 90 |
| Example 28 | Graphite | | LiCoO₂ | Example 1 | 91 |
| Example 29 | Silicon | | LiCoO₂ | LZC | 71 |
| Example 30 | Tin | | LiCoO₂ | LZC | 70 |
| Example 31 | Lithium | | LiCoO₂ | LZC | 80 |
| Example 32 | None | | LiCoO₂ | LZC | 52 |
| Comparative | Graphite | Comparative | LiCoO₂ | LZC | 59 |
| Example 9 | | Example 1 | | | |
| Comparative | Graphite | Comparative | LiCoO₂ | LZC | 59 |
| Example 10 | | Example 2 | | | |
| Comparative | Graphite | Comparative | LiCoO₂ | LZC | 57 |
| Example 11 | | Example 3 | | | |
| Comparative | Graphite | Comparative | LiCoO₂ | LZC | 29 |
| Example 12 | | Example 5 | | | |
| Comparative | Graphite | Comparative | LiCoO₂ | LZC | 29 |
| Example 13 | | Example 6 | | | |
| Comparative | Graphite | Comparative | LiCoO₂ | LZC | 28 |
| Example 14 | | Example 7 | | | |
| Comparative | Graphite | Comparative | LiCoO₂ | LZC | 28 |
| Example 15 | | Example 8 | | | |
| Comparative | Silicon | Comparative | LiCoO₂ | LZC | 51 |
| Example 16 | | Example 1 | | | |
| Comparative | Tin | Comparative | LiCoO₂ | LZC | 52 |
| Example 17 | | Example 1 | | | |
| Comparative | Lithium | Comparative | LiCoO₂ | LZC | 49 |
| Example 18 | | Example 1 | | | |
| Comparative | Lithium | Comparative | LiCoO₂ | LZC | 24 |
| Example 19 | | Example 2 | | | |
| Comparative | Lithium | Comparative | LiCoO₂ | LZC | 23 |
| Example 20 | | Example 3 | | | |
| Comparative | None | Comparative | LiCoO₂ | LZC | 25 |
| Example 21 | | Example 1 | | | |

TABLE 4

| | Constituent raw materials of negative electrode electrolyte | | | | | | | | |
|---|---|---|---|---|---|---|---|---|---|
| | Raw | Molar | Raw | Molar | Raw | Molar | Raw | Molar | Production |
| | material 1 | ratio | material 2 | ratio | material 3 | ratio | material 4 | ratio | Method |
| Example 15 | ZrCl₄ | 1 | Li₂SO₄ | 1 | P₂O₅ | 0.07 | | | First method |
| Example 16 | ZrCl₄ | 1 | Li₂SO₄ | 1 | PCl₅ | 0.07 | | | First method |
| Example 17 | ZrCl₄ | 1 | Li₂SO₄ | 1 | P₂O₅ | 0.14 | | | Second |
| | | | | | | | | | method |
| Example 18 | ZrCl₄ | 1 | Li₂SO₄ | 1 | P₂O₅ | 0.23 | | | Second |
| | | | | | | | | | method |
| Example 19 | ZrCl₄ | 1 | Li₂SO₄ | 1 | P₂O₅ | 0.29 | | | Second |
| | | | | | | | | | method |
| Example 20 | ZrCl₄ | 1 | Li₂SO₄ | 1 | P₂O₅ | 0.015 | | | Second |
| | | | | | | | | | method |
| Example 21 | ZrCl₄ | 1 | Li₂SO₄ | 0.7 | P₂Os | 0.07 | | | Second |
| | | | | | | | | | method |
| Example 22 | ZrCl₄ | 1 | Li₂SO₄ | 0.6 | P₂O₅ | 0.07 | | | Second |
| | | | | | | | | | method |
| Example 23 | ZrCl₄ | 1 | Li₂SO₄ | 2 | P₂O₅ | 0.07 | | | Second |
| | | | | | | | | | method |
| Example 24 | ZrCl₄ | 1 | Li₂SO₄ | 3 | P₂O | 0.07 | | | Second |
| | | | | | | | | | method |
| Example 25 | ZrCl₄ | 1 | Li₂SO₄ | 0.6 | P₂O₅ | 0.07 | LiCl | 1 | Second |
| | | | | | | | | | method |
| Example 26 | ZrCl₄ | 1 | Li₂SO₄ | 0.4 | P₂O₅ | 0.07 | LiCl | 1 | Second |
| | | | | | | | | | method |
| Example 27 | ZrCl₄ | 1 | Li₂SO₄ | 1 | P₂O₅ | 0.07 | | | First method |
| Example 28 | ZrCl₄ | 1 | Li₂SO₄ | 1 | P₂O₅ | 0.07 | | | Second |
| | | | | | | | | | method |
| Example 29 | ZrCl₄ | 1 | Li₂SO₄ | 1 | P₂O₅ | 0.14 | | | Second |
| | | | | | | | | | method |
| Example 30 | ZrCl₄ | 1 | Li₂SO₄ | 1 | P₂O₅ | 0.14 | | | Second |
| | | | | | | | | | method |
| Example 31 | | | | | | | | | |
| Example 32 | | | | | | | | | |
| Comparative | ZrCl₄ | 1 | Li₂SO₄ | 1 | | | | | Second |
| Example 9 | | | | | | | | | method |
| Comparative | ZrCl₄ | 1 | Li₂SO₄ | 1 | P₂O₅ | 0.31 | | | Second |
| Example 10 | | | | | | | | | method |
| Comparative | ZrCl₄ | 1 | Li₂SO₄ | 1 | P₂O₅ | 0.34 | | | Second |
| Example 11 | | | | | | | | | method |
| Comparative | ZrCl₄ | 1 | Li₂O | 1 | P₂O₅ | 0.1 | | | Second |
| Example 12 | | | | | | | | | method |
| Comparative | ZrCl₄ | 1 | Li₂O | 1 | P₂O | 0.3 | | | Second |
| Example 13 | | | | | | | | | method |
| Comparative | ZrCl₄ | 1 | Li₂O | 1 | | | | | Second |
| Example 14 | | | | | | | | | method |
| Comparative | ZrCl₄ | 1 | Li₃PO₄ | 1 | | | | | Second |
| Example 15 | | | | | | | | | method |
| Comparative | ZrCl₄ | 1 | Li₂SO₄ | 1 | | | | | Second |
| Example 16 | | | | | | | | | method |
| Comparative | ZrCl₄ | 1 | Li₂SO₄ | 1 | | | | | Second |
| Example 17 | | | | | | | | | method |
| Comparative | ZrCl₄ | 1 | Li₂SO₄ | 1 | | | | | Second |
| Example 18 | | | | | | | | | method |
| Comparative | | | | | | | | | |
| Example 19 | | | | | | | | | |
| Comparative | | | | | | | | | |
| Example 20 | | | | | | | | | |
| Comparative | | | | | | | | | |
| Example 21 | | | | | | | | | |

TABLE 5

| | Negative electrode solid electrolyte | | | | Presence or | Presence or | |
|---|---|---|---|---|---|---|---|
| | Molar | Molar | Molar | Molar | absence of | absence of | Ionic |
| | ratio | ratio | ratio | ratio | phosphorus | lithium | conductivity |
| | Li/Zr | SOₓ/Zr | P/Zr | Cl/Zr | compound | oxide | (mS/cm) |
| Example 15 | 2 | 1 | 0.14 | 4 | Present | Absent | 0.5 |
| Example 16 | 2 | 1 | 0.07 | 4.35 | Present | Absent | 0.62 |
| Example 17 | 2 | 1 | 0.28 | 4 | Absent | Absent | 0.35 |
| Example 18 | 2 | 1 | 0.46 | 4 | Absent | Absent | 0.15 |
| Example 19 | 2 | 1 | 0.58 | 4 | Absent | Absent | 0.1 |
| Example 20 | 2 | 1 | 0.03 | 4 | Absent | Absent | 1.0 |
| Example 21 | 1.4 | 0.7 | 0.14 | 4 | Absent | Absent | 0.72 |
| Example 22 | 1.2 | 0.6 | 0.14 | 4 | Absent | Absent | 0.81 |
| Example 23 | 4 | 2 | 0.14 | 4 | Absent | Absent | 0.45 |
| Example 24 | 6 | 3 | 0.14 | 4 | Absent | Absent | 0.3 |
| Example 25 | 2.2 | 0.6 | 0.14 | 5 | Absent | Absent | 0.78 |
| Example 26 | 1.8 | 0.4 | 0.14 | 5 | Absent | Absent | 0.8 |
| Example 27 | 2 | 1 | 0.14 | 4 | Present | Present | 0.5 |
| Example 28 | 2 | 1 | 0.14 | 4 | Absent | Absent | 0.5 |
| Example 29 | 2 | 1 | 0.28 | 4 | Absent | Absent | 0.35 |
| Example 30 | 2 | 1 | 0.28 | 4 | Absent | Absent | 0.35 |
| Example 31 | | | | | | | |
| Example 32 | | | | | | | |
| Comparative | 2 | 1 | 0 | 4 | Absent | Absent | 1.8 |
| Example 9 | | | | | | | |
| Comparative | 2 | 1 | 0.62 | 4 | Absent | Absent | 0.005 |
| Example 10 | | | | | | | |
| Comparative | 2 | 1 | 0.68 | 4 | Absent | Absent | 0.001 |
| Example 11 | | | | | | | |
| Comparative | 2 | 1 | 0.2 | 4 | Absent | Absent | 1.3 |
| Example 12 | | | | | | | |
| Comparative | 2 | 0 | 0.6 | 4 | Absent | Absent | 0.42 |
| Example 13 | | | | | | | |
| Comparative | 2 | 0 | 0 | 4 | Absent | Absent | 3 |
| Example 14 | | | | | | | |
| Comparative | 3 | 0 | 1 | 4 | Absent | Absent | 1.5 |
| Example 15 | | | | | | | |
| Comparative | 2 | 1 | 0 | 4 | Absent | Absent | 1.8 |
| Example 16 | | | | | | | |
| Comparative | 2 | 1 | 0 | 4 | Absent | Absent | 1.8 |
| Example 17 | | | | | | | |
| Comparative | 2 | 1 | 0 | 4 | Absent | Absent | 1.8 |
| Example 18 | | | | | | | |
| Comparative | | | | | | | |
| Example 19 | | | | | | | |
| Comparative | | | | | | | |
| Example 20 | | | | | | | |
| Comparative | | | | | | | |
| Example 21 | | | | | | | |

Examples 15 to 32 exhibited improved initial charge-discharge efficiency compared to the comparative examples under equivalent conditions.

### Examples 35 to 55

In Examples 35 to 55, solid electrolytes were prepared under the production conditions summarized in Table 6 below. In addition, in the same manner as in Example 1, the ionic conductivity and the voltage after the elapse of 100 hours of the solid electrolytes of Examples 35 to 55 were measured, and the results are summarized in Table 7.

TABLE 6

| | Raw material ratio | | | | | | | | | | |
|---|---|---|---|---|---|---|---|---|---|---|---|
| | Raw | Molar | Raw | Molar | Raw | Molar | Raw | Molar | Raw | Molar | Production |
| | Material 1 | ratio | Material 2 | ratio | Material 3 | ratio | Material 4 | ratio | Material 5 | ratio | method |
| Example | ZrCl₄ | 1 | Li₂SO₃ | 1 | P₂O₅ | 0.1 | | | | | Second |
| 35 | | | | | | | | | | | method |
| Example | ZrCl₄ | 1 | Li₂SO₃ | 1 | P₂O₅ | 0.2 | | | | | Second |
| 36 | | | | | | | | | | | method |
| Example | ZrCl₄ | 1 | Li₂SO₃ | 1 | P₂O₅ | 0.29 | | | | | First |
| 37 | | | | | | | | | | | method |
| Example | ZrCl₄ | 1 | Li₂S₂O₃ | 1 | P₂O | 0.1 | | | | | Second |
| 38 | | | | | | | | | | | method |
| Example | ZrCl₄ | 1 | Li₂S₂O₃ | 1 | P₂O₅ | 0.2 | | | | | Second |
| 39 | | | | | | | | | | | method |
| Example | ZrCl₄ | 1 | Li₂S₂O₃ | 1 | P₂O₅ | 0.29 | | | | | First |
| 40 | | | | | | | | | | | method |
| Example | ZrCl₄ | 1 | Li₂S₄O₆ | 0.7 | P₂O₅ | 0.1 | | | | | Second |
| 41 | | | | | | | | | | | method |
| Example | ZrCl₄ | 1 | Li₂S₄O₆ | 0.7 | P₂O₅ | 0.2 | | | | | Second |
| 42 | | | | | | | | | | | method |
| Example | ZrCl₄ | 1 | Li₂S₄O₆ | 0.7 | P₂O₅ | 0.29 | | | | | First |
| 43 | | | | | | | | | | | method |
| Example | ZrCl₄ | 1 | Li₂SO₄ | 0.75 | Li₂SO₃ | 0.25 | P₂O₅ | 0.1 | | | Second |
| 44 | | | | | | | | | | | method |
| Example | ZrCl₄ | 1 | Li₂SO₄ | 0.5 | Li₂SO₃ | 0.5 | P₂O₅ | 0.1 | | | Second |
| 45 | | | | | | | | | | | method |
| Example | ZrCl₄ | 1 | Li₂SO₄ | 0.25 | Li₂SO₃ | 0.75 | P₂O₅ | 0.1 | | | Second |
| 46 | | | | | | | | | | | method |
| Example | ZrCl₄ | 1 | Li₂SO₄ | 0.5 | Li₂SO₃ | 0.25 | Li₂S₂O₃ | 0.25 | P₂O₅ | 0.1 | First |
| 47 | | | | | | | | | | | method |
| Example | ZrCl₄ | 1 | Li₂SO₄ | 0.25 | Li₂SO₃ | 0.25 | Li₂S₂O₃ | 0.5 | P₂O | 0.1 | Second |
| 48 | | | | | | | | | | | method |
| Example | ZrCl₄ | 1 | Li₂SO₄ | 0.5 | Li₂SO₃ | 0.25 | Li₂S₂O₃ | 0.25 | P₂O₆ | 0.1 | Second |
| 49 | | | | | | | | | | | method |
| Example | ZrCl₄ | 1 | MgS₂O₃ | 0.15 | Li₂SO₄ | 0.85 | P₂O₅ | 0.1 | | | Second |
| 50 | | | | | | | | | | | method |
| Example | ZrCl₄ | 1 | MgS₂O₃ | 0.15 | Li₂SO₃ | 0.85 | P₂O₅ | 0.1 | | | Second |
| 51 | | | | | | | | | | | method |
| Example | ZrCl₄ | 1 | Na₂S₂O₃ | 0.15 | Li₂SO₄ | 0.85 | P₂O₅ | 0.1 | | | Second |
| 52 | | | | | | | | | | | method |
| Example | ZrCl₄ | 1 | Na₂S₂O₃ | 0.15 | Li₂SO₃ | 0.85 | P₂O₅ | 0.1 | | | Second |
| 53 | | | | | | | | | | | method |
| Example | ZrCl₄ | 0.75 | ZrF₄ | 0.25 | Li₂SO₄ | 1 | P₂O₅ | 0.05 | | | Second |
| 54 | | | | | | | | | | | method |
| Example | ZrCl₄ | 0.75 | ZrF₄ | 0.25 | Li₂SO₃ | 1 | P₂O₅ | 0.05 | | | Second |
| 55 | | | | | | | | | | | method |

TABLE 7

| | Solid electrolyte layer | | | | Presence or | Presence | | |
|---|---|---|---|---|---|---|---|---|
| | Molar | Molar | Molar | Molar | absence of | or absence | Ionic | Overvoltage |
| | ratio | ratio | ratio | ratio | phosphorus | of lithium | conductivity | increase |
| | Li/Zr | SOₓ/Zr | P/Zr | Cl/Zr | compound | oxide | (mS/cm) | (mV) |
| Example | 2 | 1 | 0.2 | 4 | Absent | Absent | 0.71 | 19.5 |
| 35 | | | | | | | | |
| Example | 2 | 1 | 0.4 | 4 | Absent | Absent | 0.5 | 15.6 |
| 36 | | | | | | | | |
| Example | 2 | 1 | 0.58 | 4 | Present | Absent | 0.2 | 12.8 |
| 37 | | | | | | | | |
| Example | 2 | 2 | 0.2 | 4 | Absent | Absent | 0.6 | 20.5 |
| 38 | | | | | | | | |
| Example | 2 | 2 | 0.4 | 4 | Absent | Absent | 0.5 | 19.5 |
| 39 | | | | | | | | |
| Example | 2 | 2 | 0.58 | 4 | Present | Absent | 0.43 | 13.6 |
| 40 | | | | | | | | |
| Example | 1.4 | 2.8 | 0.2 | 4 | Absent | Absent | 0.6 | 20.1 |
| 41 | | | | | | | | |
| Example | 1.4 | 2.8 | 0.4 | 4 | Absent | Absent | 0.5 | 19 |
| 42 | | | | | | | | |
| Example | 1.4 | 2.8 | 0.58 | 4 | Present | Absent | 0.4 | 15.1 |
| 43 | | | | | | | | |
| Example | 2 | 1 | 0.2 | 4 | Absent | Absent | 0.82 | 21.2 |
| 44 | | | | | | | | |
| Example | 2 | 1 | 0.2 | 4 | Absent | Absent | 0.7 | 22.1 |
| 45 | | | | | | | | |
| Example | 2 | 1 | 0.2 | 4 | Absent | Absent | 0.75 | 23.5 |
| 46 | | | | | | | | |
| Example | 2 | 1.25 | 0.2 | 4 | Present | Absent | 0.78 | 24.1 |
| 47 | | | | | | | | |
| Example | 2 | 1.5 | 0.2 | 4 | Absent | Absent | 0.81 | 21.4 |
| 48 | | | | | | | | |
| Example | 2 | 1.25 | 0.2 | 4 | Absent | Absent | 0.79 | 19.8 |
| 49 | | | | | | | | |
| Example | 1.7 | 1.15 | 0.2 | 4 | Absent | Absent | 0.3 | 24.1 |
| 50 | | | | | | | | |
| Example | 1.7 | 1.15 | 0.2 | 4 | Absent | Absent | 0.4 | 23.1 |
| 51 | | | | | | | | |
| Example | 1.7 | 1.15 | 0.2 | 4 | Absent | Absent | 0.5 | 19.9 |
| 52 | | | | | | | | |
| Example | 1.7 | 1.15 | 0.2 | 4 | Absent | Absent | 0.55 | 20.9 |
| 53 | | | | | | | | |
| Example | 2.67 | 1 | 0.1 | 4 | Absent | Absent | 0.2 | 19.5 |
| 54 | | | | | | | | |
| Example | 2.67 | 1 | 0.1 | 4 | Absent | Absent | 0.15 | 18.9 |
| 55 | | | | | | | | |

### Examples 56 to 81

In Examples 56 to 81, solid electrolyte batteries were manufactured under the production conditions summarized in Tables 8 to 10 below. Furthermore, the initial efficiency of the solid electrolyte batteries of Examples 56 to 81 was measured in the same manner as in Example 15, and the results are summarized in Table 8. In addition, Table 9 summarizes the production conditions of the solid electrolytes contained in the negative electrode active materials, and Table 10 summarizes the evaluation results of the solid electrolytes contained in the negative electrode active materials.

TABLE 8

| | Negative electrode | | Positive electrode | | |
|---|---|---|---|---|---|
| | Negative electrode | Solid electrolyte | Positive electrode | Solid | Initial |
| | active material | layer | active material | electrolyte | efficiency (%) |
| Example | Graphite | Example 36 | LiCoO₂ | LZC | 91 |
| 56 | | | | | |
| Example | Graphite | | LiCoO₂ | LZC | 93 |
| 57 | | | | | |
| Example | Graphite | | LiCoO₂ | LZC | 94 |
| 58 | | | | | |
| Example | Graphite | | LiCoO₂ | LZC | 90 |
| 59 | | | | | |
| Example | Graphite | | LiCoO₂ | LZC | 91 |
| 60 | | | | | |
| Example | Graphite | | LiCoO₂ | LZC | 92 |
| 61 | | | | | |
| Example | Graphite | | LiCoO₂ | LZC | 90 |
| 62 | | | | | |
| Example | Graphite | | LiCoO₂ | LZC | 91 |
| 63 | | | | | |
| Example | Graphite | | LiCoO₂ | LZC | 92 |
| 64 | | | | | |
| Example | Graphite | | LiCoO₂ | LZC | 90 |
| 65 | | | | | |
| Example | Graphite | | LiCoO₂ | LZC | 91 |
| 66 | | | | | |
| Example | Graphite | | LiCoO₂ | LZC | 90 |
| 67 | | | | | |
| Example | Graphite | | LiCoO₂ | Example 1 | 90 |
| 68 | | | | | |
| Example | Graphite | | LiCoO₂ | LZC | 89 |
| 69 | | | | | |
| Example | Graphite | | LiCoO₂ | LZC | 91 |
| 70 | | | | | |
| Example | Graphite | | LiCoO₂ | LZC | 93 |
| 71 | | | | | |
| Example | Graphite | | LiCoO₂ | LZC | 90 |
| 72 | | | | | |
| Example | Graphite | | LiCoO₂ | LZC | 91 |
| 73 | | | | | |
| Example | Graphite | | LiCoO₂ | LZC | 92 |
| 74 | | | | | |
| Example | Graphite | | LiCoO₂ | LZC | 89 |
| 75 | | | | | |
| Example | Graphite | | LiCoO₂ | LZC | 90 |
| 76 | | | | | |
| Example | Silicon | | LiCoO₂ | LZC | 93 |
| 77 | | | | | |
| Example | Silicon | | LiCoO₂ | LZC | 94 |
| 78 | | | | | |
| Example | Tin | | LiCoO₂ | LZC | 92 |
| 79 | | | | | |
| Example | Lithium | | LiCoO₂ | LZC | 83 |
| 80 | | | | | |
| Example | None | | LiCoO₂ | LZC | 57 |
| 81 | | | | | |

TABLE 9

| | Constituent raw materials of negative electrode electrolyte | | | | | | | | | | |
|---|---|---|---|---|---|---|---|---|---|---|---|
| | Raw | Molar | Raw | Molar | Raw | Molar | Raw | Molar | Raw | Molar | Production |
| | Material 1 | ratio | Material 2 | ratio | Material 3 | ratio | Material 4 | ratio | Material 5 | ratio | method |
| Example | ZrCl₄ | 1 | Li₂SO₃ | 1 | P₂O₅ | 0.1 | | | | | Second |
| 56 | | | | | | | | | | | method |
| Example | ZrCl₄ | 1 | Li₂SO₃ | 1 | P₂O₅ | 0.2 | | | | | Second |
| 57 | | | | | | | | | | | method |
| Example | ZrCl₄ | 1 | Li₂SO₃ | 1 | P₂O₅ | 0.29 | | | | | Second |
| 58 | | | | | | | | | | | method |
| Example | ZrCl₄ | 1 | Li₂S₂O₃ | 1 | P₂O₅ | 0.1 | | | | | Second |
| 59 | | | | | | | | | | | method |
| Example | ZrCl₄ | 1 | Li₂S₂O₃ | 1 | P₂O₅ | 0.2 | | | | | Second |
| 60 | | | | | | | | | | | method |
| Example | ZrCl₄ | 1 | Li₂S₂O₃ | 1 | P₂O₅ | 0.29 | | | | | Second |
| 61 | | | | | | | | | | | method |
| Example | ZrCl₄ | 1 | Li₂S₄O₆ | 0.7 | P₂O₅ | 0.1 | | | | | Second |
| 62 | | | | | | | | | | | method |
| Example | ZrCl₄ | 1 | Li₂S₄O₆ | 0.7 | P₂O₅ | 0.2 | | | | | Second |
| 63 | | | | | | | | | | | method |
| Example | ZrCl₄ | 1 | Li₂S₄O₆ | 0.7 | P₂O₅ | 0.29 | | | | | Second |
| 64 | | | | | | | | | | | method |
| Example | ZrCl₄ | 1 | Li₂SO₄ | 0.75 | Li₂SO₃ | 0.25 | P₂O₅ | 0.1 | | | Second |
| 65 | | | | | | | | | | | method |
| Example | ZrCl₄ | 1 | Li₂SO₄ | 0.5 | Li₂SO₃ | 0.5 | P₂O₅ | 0.1 | | | Second |
| 66 | | | | | | | | | | | method |
| Example | ZrCl₄ | 1 | Li₂SO₄ | 0.25 | Li₂SO₃ | 0.75 | P₂O₅ | 0.1 | | | Second |
| 67 | | | | | | | | | | | method |
| Example | ZrCl₄ | 1 | Li₂SO₄ | 0.5 | Li₂SO₃ | 0.25 | Li₂S₂O₃ | 0.25 | P₂O₅ | 0.1 | Second |
| 68 | | | | | | | | | | | method |
| Example | ZrCl₄ | 1 | Li₂SO₄ | 0.25 | Li₂SO₃ | 0.25 | Li₂S₂O₃ | 0.5 | P₂O₅ | 0.1 | Second |
| 69 | | | | | | | | | | | method |
| Example | ZrCl₄ | 1 | Li₂SO₄ | 0.5 | Li₂SO₃ | 0.25 | Li₂S₂O₃ | 0.25 | P₂O₅ | 0.1 | Second |
| 70 | | | | | | | | | | | method |
| Example | ZrCl₄ | 1 | MgS₂O₃ | 0.15 | Li₂SO₄ | 0.85 | P₂O₅ | 0.1 | | | Second |
| 71 | | | | | | | | | | | method |
| Example | ZrCl₄ | 1 | MgS₂O₃ | 0.15 | Li₂SO₃ | 0.85 | P₂O₅ | 0.1 | | | Second |
| 72 | | | | | | | | | | | method |
| Example | ZrCl₄ | 1 | Na₂S₂O₃ | 0.15 | Li₂SO₄ | 0.85 | P₂O₅ | 0.1 | | | Second |
| 73 | | | | | | | | | | | method |
| Example | ZrCl₄ | 1 | Na₂S₂O₃ | 0.15 | Li₂SO₃ | 0.85 | P₂O₅ | 0.1 | | | Second |
| 74 | | | | | | | | | | | method |
| Example | ZrCl₄ | 0.75 | ZrF₄ | 0.25 | Li₂SO₄ | 1 | P₂O₅ | 0.05 | | | Second |
| 75 | | | | | | | | | | | method |
| Example | ZrCl₄ | 0.75 | ZrF₄ | 0.25 | Li₂SO₃ | 1 | P₂O₅ | 0.05 | | | Second |
| 76 | | | | | | | | | | | method |
| Example | ZrCl₄ | 1 | Li₂SO₃ | 1 | P₂O₅ | 0.1 | | | | | Second |
| 77 | | | | | | | | | | | method |
| Example | ZrCl₄ | 1 | Li₂SO₃ | 1 | P₂O₅ | 0.2 | | | | | Second |
| 78 | | | | | | | | | | | method |
| Example | ZrCl₄ | 1 | Li₂SO₃ | 1 | P₂O₅ | 0.1 | | | | | Second |
| 79 | | | | | | | | | | | method |
| Example | | | | | | | | | | | |
| 80 | | | | | | | | | | | |
| Example | | | | | | | | | | | |
| 81 | | | | | | | | | | | |

TABLE 10

| | Solid electrolyte layer of the negative electrode | | | | Presence or | Presence | |
|---|---|---|---|---|---|---|---|
| | Molar | Molar | Molar | Molar | absence of | or absence | Ionic |
| | ratio | ratio | ratio | ratio | phosphorus | of lithium | conductivity |
| | Li/Zr | SOₓ/Zr | P/Zr | Cl/Zr | compound | oxide | (mS/cm) |
| Example 56 | 2 | 1 | 0.2 | 4 | Present | Absent | 0.71 |
| Example 57 | 2 | 1 | 0.4 | 4 | Present | Absent | 0.5 |
| Example 58 | 2 | 1 | 0.58 | 4 | Absent | Absent | 0.2 |
| Example 59 | 2 | 2 | 0.2 | 4 | Absent | Absent | 0.6 |
| Example 60 | 2 | 2 | 0.4 | 4 | Absent | Absent | 0.5 |
| Example 61 | 2 | 2 | 0.58 | 4 | Absent | Absent | 0.43 |
| Example 62 | 1.4 | 2.8 | 0.2 | 4 | Absent | Absent | 0.6 |
| Example 63 | 1.4 | 2.8 | 0.4 | 4 | Absent | Absent | 0.5 |
| Example 64 | 1.4 | 2.8 | 0.58 | 4 | Absent | Absent | 0.4 |
| Example 65 | 2 | 1 | 0.2 | 4 | Absent | Absent | 0.82 |
| Example 66 | 2 | 1 | 0.2 | 4 | Absent | Absent | 0.7 |
| Example 67 | 2 | 1 | 0.2 | 4 | Present | Absent | 0.75 |
| Example 68 | 2 | 1.25 | 0.2 | 4 | Absent | Absent | 0.78 |
| Example 69 | 2 | 1.5 | 0.2 | 4 | Absent | Absent | 0.81 |
| Example 70 | 2 | 1.25 | 0.2 | 4 | Absent | Absent | 0.79 |
| Example 71 | 1.7 | 1.15 | 0.2 | 4 | Absent | Absent | 0.3 |
| Example 72 | 1.7 | 1.15 | 0.2 | 4 | Absent | Absent | 0.4 |
| Example 73 | 1.7 | 1.15 | 0.2 | 4 | Absent | Absent | 0.5 |
| Example 74 | 1.7 | 1.15 | 0.2 | 4 | Absent | Absent | 0.55 |
| Example 75 | 2.67 | 1 | 0.1 | 4 | Absent | Absent | 0.2 |
| Example 76 | 2.67 | 1 | 0.1 | 4 | Absent | Absent | 0.15 |
| Example 77 | 2 | 1 | 0.2 | 4 | Absent | Absent | 0.71 |
| Example 78 | 2 | 1 | 0.4 | 4 | Absent | Absent | 0.5 |
| Example 79 | 2 | 1 | 0.2 | 4 | Absent | Absent | 0.71 |
| Example 80 | | | | | | | |
| Example 81 | | | | | | | |

Examples 56 to 81 exhibited improved initial charge-discharge efficiency compared to the comparative examples under equivalent conditions.

### INDUSTRIAL APPLICABILITY

It is possible to provide a solid electrolyte battery in which the solid electrolyte is less likely to be reduced and which has high stability.

### REFERENCE SIGNS LIST

10 Solid electrolyte layer
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Solid electrolyte battery

1. A solid electrolyte battery comprising:
a positive electrode;
a negative electrode; and
a solid electrolyte layer sandwiched between the positive electrode and the negative electrode,
wherein the solid electrolyte layer contains a solid electrolyte containing Li, Zr, SOₓ, and one or more halogens,
wherein a first region of the solid electrolyte layer which is in contact with the negative electrode contains P,
wherein the solid electrolyte layer has
a molar ratio of SOₓ to Zr of 0.25 to 3.0,
a molar ratio of P to Zr of 0.02 to 0.6, and
a molar ratio of the halogens to Zr of 3.0 to 6.1.

2. The solid electrolyte battery according to claim 1,
wherein the solid electrolyte layer has a molar ratio of Li to Zr of 1.5 to 5.0.

3. The solid electrolyte battery according to claim 1,
wherein the solid electrolyte layer has a molar ratio of SOₓ to Zr of 1.0 to 3.0.

4. The solid electrolyte battery according to claim 1,
wherein the solid electrolyte layer has a molar ratio of P to Zr of 0.05 to 0.3.

5. The solid electrolyte battery according to claim 1,
wherein the first region contains a phosphorus compound.

6. The solid electrolyte battery according to claim 5,
wherein the phosphorus compound contains a phosphorus oxide.

7. The solid electrolyte battery according to claim 1,
wherein the solid electrolyte layer contains lithium oxide powder.

8. The solid electrolyte battery according to claim 1,
wherein the negative electrode has a negative electrode current collector and a negative electrode active material layer,
wherein the negative electrode active material layer is provided between the negative electrode current collector and the solid electrolyte layer, and
wherein the negative electrode active material layer contains lithium metal.

9. The solid electrolyte battery according to claim 1,
wherein the negative electrode has a negative electrode current collector, and
wherein lithium metal precipitates between the negative electrode current collector and the solid electrolyte layer during charging, and dissolves during discharging.

10. The solid electrolyte battery according to claim 1,
wherein the negative electrode has a negative electrode current collector and a negative electrode active material layer,
wherein the negative electrode active material layer is provided between the negative electrode current collector and the solid electrolyte layer, and
wherein the negative electrode active material layer contains any one or more selected from graphite, silicon, tin, and silver.

11. The solid electrolyte battery according to claim 1,
wherein the negative electrode contains the solid electrolyte and P, and
wherein the negative electrode has
a molar ratio of SOₓ to Zr of 0.25 to 3.0,
a molar ratio of P to Zr of 0.02 to 0.6, and
a molar ratio of the halogens to Zr of 3.0 to 6.1.

12. The solid electrolyte battery according to claim 11,
wherein the negative electrode has a molar ratio of Li to Zr of 1.5 to 5.0.

13. The solid electrolyte battery according to claim 11,
wherein the negative electrode has a molar ratio of SOₓ to Zr of 1.0 to 3.0.

14. The solid electrolyte battery according to claim 11,
wherein the negative electrode has a molar ratio of P to Zr of 0.05 to 0.3.

15. The solid electrolyte battery according to claim 11,
wherein the negative electrode contains a phosphorus compound.

16. The solid electrolyte battery according to claim 15,
wherein the phosphorus compound contains a phosphorus oxide.

17. The solid electrolyte battery according to claim 11,
wherein the negative electrode contains lithium oxide powder.

18. The solid electrolyte battery according to claim 1,
wherein the positive electrode contains the solid electrolyte and P, and
wherein the positive electrode has
a molar ratio of SOₓ to Zr of 0.25 to 3.0,
a molar ratio of P to Zr of 0.02 to 0.6, and
a molar ratio of the halogens to Zr of 3.0 to 6.1.
